(19) United States
(12) Patent Application Publication
(10) Pub. No.: US 2008/0113236 A1
(43) Pub. Date: May 15, 2008

(54) FUEL CELL WITH DEVICE FOR DETERMINING THE OXYGEN CONTENT IN THE SUPPLIED AIR

(76) Inventors: Juergen Binder, Filderstadt-Plattenhardt (DE); Ulrich Gottwick, Stuttgart (DE); Jan-Michael Graehn, Stuttgart (DE); Jens Intorp, Stuttgart (DE); Arthur Schaefert, Buehlertal (DE); Gunter Wiedemann, Ludwigsburg (DE); Eduard Saar, Steinheim (DE)

Correspondence Address: Striker, Striker & Stenby, 103 East Neck Road, Hungtington, NY, 11743, US

(21) Appl. No.: 11/861,671

(22) Filed: Sep. 26, 2007

(30) Foreign Application Priority Data
Sep. 28, 2006 (DE) 102006045922.9

(51) Int. Cl. H01M 8/04

(52) U.S. Cl. 429/22; 429/23

(57) ABSTRACT

The present invention relates to a fuel cell (1) with an air-supplied cathode region (2) and a device (3) for determining the oxygen content in the supplied air. It is characterized by the fact that a fuel cell operating state control unit (3) is provided, which determines the operating state for the mobile operation of the fuel cell based on the oxygen content that was determined.

The present invention relates to a fuel cell with a device for determining the oxygen content in the supplied air, according to the preamble of Claim 1.

### RELATED ART

Fuel cells are operated on the cathode side with oxygen that is preferably obtained from the surrounding air. The use of an oxygen sensor for the stationary operation of fuel cells in closed rooms is known. When a certain limiting value for the oxygen content in this room is fallen below, it is therefore possible to initiate a shut-off of the fuel cell for safety reasons.

### OBJECT AND ADVANTAGES OF THE PRESENT INVENTION

The object of the present invention is to improve a fuel cell based on the related art described above.

This object is attained via the features of claim 1. The features of the dependent claims describe further advantageous embodiments.

Accordingly, the present invention relates to a fuel cell with an air-supplied cathode region and a device for determining the oxygen content in the supplied air. It is characterized by the fact that a fuel cell operating state control unit is provided, which determines the operating state for the mobile operation of the fuel cell based on the oxygen content that was determined. The advantage of an operating state control of this type for mobile operation of the fuel cell is that drops in output, e.g., due to a drop in oxygen content for a fuel cell-operated vehicle that is driven through a tunnel, for instance, or when it driven in a parking garage, may be compensated for—at least temporarily, and as needed—by increasing the air supply and/or the pressure.

In addition to a first operating state determination of this type carried out by the operating state control unit based on the oxygen content that was determined, it is also possible—e.g., in another operating state, with the opposite intention, i.e., to use the oxygen content sparingly—to reduce the output required of the fuel cell, e.g., by shutting off various consumers in a prioritized manner. It is possible, for example, to reduce the output of a heating system and/or air conditioning system or other consumers that are not absolutely required for the current operating state, or to shut them off altogether. It is therefore also possible, e.g., to operate—at least temporarily—a drive of the motor vehicle that is supplied by the fuel cell without any noticeable power losses, which could be the case, e.g., when driving through a tunnel or in a parking garage.

It is considered to be particularly advantageous when the fuel cell operating state control unit is designed to query the mobility state of the fuel cell. Therefore, when the vehicle comes to a standstill, for example, a lighting system of the vehicle that may be switched on for normal operation may be changed to an emergency lighting state to save energy. In contrast, in a driving operation state, an inquiry could be generated regarding the selection of a desired, subsequent operating state, an increase in the air supply to the fuel cell, or a reduction of the output required of the fuel cell. A query of this type could also precede a warning.

In accordance with the action desired, the fuel cell operating state control unit may set the fuel cell into the desired operating mode and initiate an increase in the air mass flow that is supplied, and/or an increase in the charge air pressure for the air flow supplied to the fuel cell, and/or a reduction in the output required of the fuel cell. A combination of one or more individual operating states of this type is also feasible, in reaction to an inadequate oxygen content in the supplied air.

In addition to the possibility of having the fuel cell operating state control unit limit the output of electrical consumers or to shut them off altogether—in a prioritized manner, in particular—this possibility may also be preferably provided to shut the fuel cell off for safety purposes. With a safety shut-off of the fuel cell of this type, the fuel cell operating state control unit may particularly preferably issue a warning, so that the driver of the fuel cell-operated vehicle—after assessing the situation and before initiating a safety shut-off of this type—may take other actions instead.

One possible exemplary embodiment is explained in greater detail below with reference to the attached drawing.

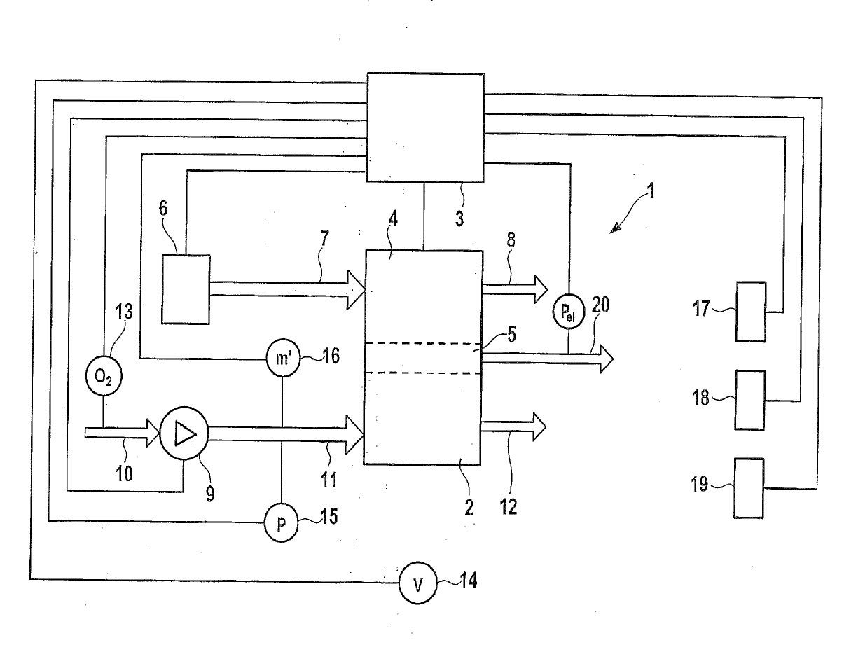

FIG. 1 shows a schematic depiction of a fuel cell with an air-supplied cathode region and a fuel cell operating state control unit, as an example.

### EXEMPLARY EMBODIMENT

Accordingly, the present invention relates to a fuel cell 1 with an air-supplied cathode region 2 and a device 13 for determining the oxygen content in the supplied air. It is characterized by the fact that a fuel cell operating state control unit 3 is provided, which determines the operating state for a mobile operation of fuel cell 1 based on the oxygen content that was determined.

In addition to cathode 2, fuel cell 1 also includes an anode 4 and a diaphragm 5, which separates them. A tank 6 is provided to supply fuel cell 1 with fuel. The inflow and outflow of fuel through the anode is depicted symbolically via arrows 7 and 8.

The cathode-side supply of fuel cell 1 with oxygen obtained from the surrounding air takes place using delivery unit 9, which may be a pump or a compressor, for example. The inflow and outflow of air is depicted symbolically via arrows 10 through 12.

An oxygen sensor 13 is provided to determine the oxygen content in the air. It may be located, e.g., upstream of delivery unit 9, as shown here. It is also feasible to locate oxygen sensor 13 between the delivery unit and the input of the cathode side of fuel cell 1.

The oxygen content in the supplied air determined by oxygen sensor 13 is communicated to fuel cell operating state control unit 3 via a related line connection. If required, it modifies the operating state of the fuel cell based on a signal received from oxygen sensor 13.

It is considered to be particularly advantageous when fuel cell operating state control unit 3 is designed to query the mobility state of fuel cell 1. A motion and/or speed detection sensor 14 provided for this purpose is shown here as an example. Depending on the operating state that is determined, i.e., the vehicle is at a standstill or driving, fuel cell operating state control unit 3 may select and implement a change in the operating state of the fuel cell—if it is determined that a minimum value for the oxygen content in supplied air flow 10, 11 has been fallen below—or it may query the driver of a fuel cell-operated vehicle as to which operating state he wants to initiate.

A first possibility of a modified operating state would be to increase the air mass flow in the supply to cathode 2 of fuel cell 1 and/or to increase the charge air pressure in this air flow. A pressure sensor 15 and a mass flow sensor 16 for querying and/or registering the applicable parameters are shown here as examples.

A further possible operating state for the fuel cell would be a reduction of the electrical power output by the fuel cell, which is depicted here symbolically with arrow 20. One possible approach may therefore be to reduce the output of consumers 17 through 19 or to shut them off partially or completely, preferably in a prioritized manner. In a first mode, e.g., it may be provided that the output of a heating system and/or air conditioning system may be reduced, which may also be switched off entirely if so required. In another mode—in a situation in which the fuel cell should deliver less electrical energy because the vehicle it is driving has come to a standstill—it would be feasible to reduce the output of the lighting system to the level of emergency operation. A further possible operating state for the fuel cell would be a safety shut-off by fuel cell operating state control unit 3, possibly with a warning being issued in advance.

What is claimed is:

1. A fuel cell (1) with an air-supplied cathode region (2) and a device (3) for determining the oxygen content in the supplied air,
wherein
a fuel cell operating state control unit (3) is provided, which determines the operating state for a mobile operation of the fuel cell based on the oxygen content that was determined.

2. The fuel cell as recited in claim 1,
wherein
the fuel cell operating state control unit (3) is provided to query the mobility state of the fuel cell.

3. The fuel cell as recited in claim 1,
wherein
the fuel cell operating state control unit (3) is provided to control the air mass flow (11) supplied to the fuel cell.

4. The fuel cell as recited in claim 1,
wherein
the fuel cell operating state control unit (3) is provided to control the charge air pressure of the air flow (11) supplied to the fuel cell.

5. The fuel cell as recited in claim 1,
wherein
the fuel cell operating state control unit (3) is provided to reduce the output to the point of limiting the electrical output provided by the fuel cell.

6. The fuel cell as recited in claim 1,
wherein
the fuel cell operating state control unit (3) is provided to reduce the output to the point of switching off any non-essential consumers (17 through 19).

7. The fuel cell as recited in one of the preceding claims claim 1,
wherein
the fuel cell operating state control unit (3) is provided to reduce output in a prioritized manner, and/or to switch off the consumers.

8. The fuel cell as recited in claim 1,
wherein
the fuel cell operating state control unit (3) is provided to shut off the fuel cell for safety purposes.
